(19) United States
(12) Patent Application Publication
(10) Pub. No.: US 2026/0200792 A1
(43) Pub. Date: Jul. 16, 2026

(54) METHOD FOR PRODUCING A PANE- OR FILM-LIKE ARTICLE WITH A DECORATIVE COATING

(71) Applicant: SAINT-GOBAIN GLASS FRANCE, COURBEVOIE (FR)

(72) Inventors: Li-Ya YEH, HERZOGENRATH (DE); Semjon MOORAJ, HERZOGENRATH (DE); Jan HAGEN, HERZOGENRATH (DE); Roberto ZIMMERMANN, HERZOGENRATH (DE)

(21) Appl. No.: 19/137,959

(22) PCT Filed: Oct. 18, 2023
(86) PCT No.: PCT/EP2023/078900

§ 371 Date: Jun. 11, 2025

(30) Foreign Application Priority Data
Dec. 12, 2022 (EP) 22212838.1

(51) Int. Cl. C03C 17/36

(52) U.S. Cl. CPC C03C 17/3684; C03C 17/3618; C03C 17/3626; C03C 17/3642; C03C 17/3644; C03C 17/3649; C03C 17/3655; C03C 17/366; C03C 17/3681; C03C 2217/72; C03C 2217/734; C03C 2217/948; C03C 2218/156; C03C 2218/328

(57) ABSTRACT

A method for producing a pane- or film-like article with a decorative coating, includes the following method procedures in the order given (a) providing a pane- or film-like substrate, (b) coating a surface of the substrate with a coating which includes at least two layers, (c) removing at least one layer in at least one decorative region of the coating by laser radiation, wherein at least one layer remains in the decorative region, wherein in at least one base region of the coating the at least one layer is not removed.

The invention relates to a method for producing a pane- or film-like article with a decorative coating as well as to a pane- or film-like article with a decorative coating and its use.

An example of a pane- or film-like article is a glass pane. Glass panes sometimes have to be designed with a decorative region through which, for example, symbols can be displayed. These can be, for example, informative symbols, company logos or similar. Such decorative regions are typically printed onto the glass pane as a decorative coating in the form of paint or enamel. This is time-consuming and costly and also disadvantageous in terms of sustainability because it makes recycling such a glass pane more difficult. Handling printing inks and enamels can also pose a health risk and be detrimental to environmental protection. A further disadvantage of such decorative regions is that there are limits to the design, especially with regard to the shape and size of the decorative regions.

Glass panes are often provided with coatings, such as IR-reflective coatings. Glass panes with coatings and decorative prints are particularly complex to manufacture. This is especially true if the coating and the print are to be applied to the same surface of the glass pane because they can sometimes interact with each other.

The present invention is based on the object of providing an improved method for producing a pane- or film-like article with a decorative coating. The decorative coating should be simple, cost-effective, non-hazardous to health and sustainable to produce. In addition, it should be possible to carry out the method on different types of substrates and the method should allow the creation of decorative regions of any shape and size.

The object is achieved by a method according to independent claim 1. Preferred embodiments are apparent from the dependent claims.

The method according to the invention for producing a pane- or film-like article with a decorative coating comprises the following method steps in the order given:
(a) providing a pane- or film-like substrate,
(b) coating a surface of the substrate with a coating comprising at least two layers,
(c) removing at least one layer in at least one partial region of the coating by means of laser radiation, wherein at least one layer remains in said partial region,
wherein, in at least one other partial region of the coating, said at least one layer is not removed. Preferably, no layer of the coating is removed at all in the at least one base region.

The partial region or partial regions in which the at least one layer of the coating is removed by means of laser radiation is also referred to as the decorative region in the sense of the invention for the sake of better differentiation. The partial region or the partial regions in which at least one layer of the coating is not removed is also referred to as the base region.

By removing the at least one layer in the decorative region, in particular the optical properties of the decorative region are changed compared to the base region. The at least one decorative region and the at least one base region therefore have different optical properties. The optical properties refer to the visible spectral range from 380 nm to 780 nm. This allows a viewer to perceive the decorative region. The optical properties can, for example, relate to the degree of transmission and reflection of the coating or the total solar energy radiated through a glazing (the so-called TTS value, for example according to ISO 13837). In a particularly advantageous embodiment, said optical properties relate to the colour of the coating. This refers in particular to the reflection colour, i.e., the colour with which light reflected from the coating is perceived by the observer.

For the observer, the at least one decorative region and the at least one base region are visually different, on which the decorative effect of the coating is based. According to the invention, the at least one decorative region is produced by laser processing of the coating, by removing at least one layer of the coating. This means that there is no need for a print in the form of paint or enamel, which is advantageous in several respects: the production of the article is simplified and made more cost-effective. In addition, the item is more sustainable and, in particular, easier to recycle. Any interaction between the print and the coating is irrelevant. The method of depositing the coating and processing it with a laser can be applied to a wide variety of different substrates, so that pane- or film-like articles of different types can be produced, making the method very flexible. These are great advantages of the present invention.

The article produced according to the invention can be in the form of a pane, plate or film. Such an article is flat with a thickness that is significantly smaller than its width and length. Pane- or plate-like articles are rigid or stiff, meaning they can only be bent slightly elastically, while film-like articles are flexible and bendable.

The shape of the decorative region or regions can be chosen arbitrarily, as can the shape of the base region or base regions. This makes it possible to create decorations of any kind.

There may be a single, contiguous base region in which a single decorative region or several decorative regions are formed like islands. Each decorative region is completely surrounded by the base region. The at least one decorative region can, for example, have the shape of a two-dimensional geometric figure, a letter or an (other) symbol. For example, company logos or information, such as arrows or inscriptions, can be displayed. If there is more than one decorative region, the decorative regions can have the same shape or different shapes. The decorative regions can be distributed in the form of a regular pattern or irregularly. The decorative region is particularly preferably designed as a symbol or letter so that information is conveyed to the viewer.

However, other arrangements of decorative region(s) and base region(s) can also be chosen. For example, a striped pattern or a checkerboard pattern can be displayed. Irregular patterns are also possible.

The proportion of the area of the decorative region or decorative regions on the whole (total area of all decorative regions) to the total area of the coating is preferably from 1% to 90%, particularly preferably from 10% to 80%.

Depending on the design of the article to be produced, the substrate can be designed as a pane, plate or film. The substrate has, for example, a thickness of from 0.01 mm to 50 mm. The substrate has a first and a second main face and a side edge face extending therebetween.

In preferred embodiments, the substrate is
a glass pane or a plastics pane, preferably with a thickness of from 0.5 mm to 10 mm;
a ceramic slab, a stone slab or a concrete slab, preferably with a thickness of from 1 mm to 10 mm; or
a polymer film, preferably with a thickness of from 0.01 mm to 1 mm.

If the substrate is a glass pane, it is preferably made of soda lime glass, as is customary for window panes. In principle, other types of glass can also be used, such as quartz glass, borosilicate glass or aluminosilicate glass. If the substrate is a plastics pane, it is preferably made of polycarbonate or polymethyl methacrylate (PMMA). If the substrate is a polymer film, it is preferably based on polyethylene terephthalate (PET), polyvinyl butyral (PVB), ethylene vinyl acetate (EVA), or polyurethane (PU). This means that the film predominantly contains said material (more than 50% by weight) and can, in addition, optionally contain further components, for example plasticisers, stabilisers, UV- or IR-absorbers.

If the substrate is a glass pane, plastics pane or polymer film, it is preferably transparent, which in the sense of the invention means that it is possible to see through the substrate. The substrate preferably has a transmittance in the visible spectral range of at least 10%, particularly preferably at least 50%, very particularly preferably at least 70%. Articles with such substrates can be used in particular as window panes or components thereof.

The substrate is preferably flat, but in principle can also be cylindrical or spherically curved. It is also possible that the method according to the invention is carried out with a flat substrate and the article thus produced is subsequently bent.

According to the invention, one of the surfaces (main faces) of the substrate is provided with the coating. In principle, it is also possible for both surfaces of the substrate to be provided with the coating.

The coating is preferably applied over the entire surface of the substrate so that the entire surface is covered with the coating. It is then optionally possible to remove the coating from regions of the surface again, for example by mechanical abrasive means or by laser ablation. For example, a surrounding edge region of the substrate can be decoated, or local regions which, as communication, sensor or camera windows, are intended to ensure the transmission of electromagnetic radiation through the pane- or film-like article (if the coating itself is not transparent to such radiation). In the final state, preferably at least 80% of the surface of the substrate is coated. In principle, however, it is also conceivable that the coating covers a smaller part of the surface, for example if the decoration is only to be provided in a comparatively small part of the substrate. Instead of a full-surface coating followed by local decoating, regions of the substrate surface can also be excluded from the coating from the outset using masking techniques.

In an advantageous embodiment, the coating is deposited on the substrate surface by vapour deposition—for example, by chemical vapour deposition (CVD), plasma-enhanced chemical vapour deposition (PECVD), or atomic layer deposition (ALD). Physical vapour deposition (PVD), for example evaporation deposition, is particularly preferred, cathode sputtering (“sputtering”) and in particular magnetic field-assisted cathode sputtering (“magnetron sputtering”) are very particularly preferred.

According to the invention, the coating has at least two individual layers. This is necessary so that at least one layer can be removed from the decorative region and yet at least one layer remains in the decorative region. The individual layers of the coating are preferably thin layers, which in particular means layers with a thickness of less than one micrometre. They are deposited flat as layer stacks on top of each other. The layer thickness of the individual layers is preferably from 10 nm to 200 nm, the total thickness of the coating is for example from 50 nm to 1000 nm.

In an advantageous embodiment, the coating has a plurality of dielectric layers. In the laser processing according to the invention, at least one dielectric layer is preferably removed from the decorative region, while at least one dielectric layer remains in the decorative region.

In the sense of the invention, a dielectric layer is understood in particular to mean a layer made of a material with a degree of electrical conductivity (reciprocal of specific resistance) of less than 10⁻⁴ S/m. Electrically conductive layers, on the other hand, are in particular layers made of a material with a degree of electrical conductivity of greater than 10⁴ S/m.

The coating can consist exclusively of a plurality of dielectric layers. For example, aesthetic coatings with a specific colour can be realised or coatings with anti-reflective properties in the visible spectral range or with reflective properties in the ultraviolet spectral range (UV range) or in the infrared spectral range (IR range). The purely dielectric coating can, for example, comprise layers with a high refractive index and layers with a low refractive index, which are arranged alternately, wherein the reflective or anti-reflective properties are caused by interference effects. The optically high-refractive layers have for example a refractive index of at least 1.8, preferably at least 2.0. The optically low-refractive dielectric layers have, for example, a refractive index of less than 1.8, preferably less than 1.6.

Common dielectric layers are based, for example, on silicon nitride, silicon-metal mixed nitrides, such as silicon zirconium nitride, titanium oxide, aluminium nitride, aluminium oxide, tin oxide, zinc oxide, tin-zinc mixed oxide, zirconium nitride, zirconium oxide or silicon oxide. If a layer of the coating is formed on the basis of a material, this means within the context of the invention that the layer consists predominantly of the material, i.e., in a proportion of at least 50% by weight, preferably at least 70% by weight, particularly preferably at least 90% by weight. The layer may also contain in particular dopants and/or impurities, preferably in a proportion of at most 10% by weight. The oxides and nitrides mentioned can be stoichiometric, substoichiometric or superstoichiometric with regard to the oxygen or nitrogen content.

Alternatively, the coating may also additionally comprise one or more electrically conductive layers. The electrically conductive layers are preferably formed on the basis of a metal, for example silver, or on the basis of a transparent conductive oxide (TCO, transparent conductive oxide), such as indium tin oxide (ITO, indium tin oxide). If a plurality of electrically conductive layers are present, adjacent conductive layers are preferably separated from one another by at least one dielectric layer. The electrically conductive layers are in particular functional layers which provide the coating with a function. For example, the electrically conductive layers can be IR-reflective in order to provide the coating with an IR-reflective function. Likewise, the electrically conductive layers can provide the coating with a heating function when the coating is electrically contacted to pass a heating current through it.

In one embodiment, the coating has an absorber layer based on a metal or a metal alloy. The thickness of the absorber layer is preferably at most 10 nm, for example from 1 nm to 10 nm, or from 2 nm to 5 nm. Preferred materials for the absorber layer are, for example, titanium (Ti) or a nickel-chromium alloy (NiCr). Alternatively, the absorber layer can also be based on a TCO, for example ITO, lithium-doped nickel oxide or aluminium- or sodium-doped zinc oxide. The absorber layer is particularly advantageous when the other layers of the coating do not have sufficient absorption of the laser radiation to be removed by the laser radiation, in particular an absorption level of less than 1%. This occurs particularly frequently when the coating otherwise only contains dielectric layers. The absorber layer can then be specifically incorporated into the coating to absorb the laser radiation, thereby removing some of the remaining layers. Preferably, exactly one absorber layer is present.

The absorber layer preferably has an absorption coefficient with respect to the laser radiation of at least 1%, particularly preferably of at least 5%, very particularly preferably of at least 10%, for example from 10% to 30%. Typically, further layers (at least one further layer in each case), in particular further dielectric layers, are arranged above and below the absorber layer. Generally, the layers above the absorber layer are removed and the layers below the absorber layer remain on the substrate. Layers below the absorber layer are those layers that have a smaller distance to the substrate surface than the absorber layer and are therefore arranged between the substrate and the absorber layer. Layers above the absorber layer, on the other hand, are layers that have a greater distance to the substrate surface than the absorber layer, so that the absorber layer is arranged between the substrate and said layers.

Typically, the coating has a primary function, which is why it is primarily intended for use on the substrate. The decorative region is then formed according to the invention from this already existing coating. Such coatings are, for example, reflection-reducing coatings, colour-imparting coatings, sun protection coatings with reflective properties in the near IR range, heatable coatings or emissivity-reducing coatings with reflective properties in the mid-IR range (especially in the range of thermal radiation of the substrate or panes connected thereto),

The coating is preferably transparent so that it is possible to see through it. This applies in particular if the substrate is also transparent and the article is intended as a window pane or part of such a window.

After coating, the decorative region (or the decorative regions) is processed using laser radiation, wherein at least one layer is removed. Said at least one layer is completely removed from the decorative region.

Preferably, the at least one layer that is removed is the topmost layer or sequence of layers of the coating. If only a single layer is removed, that layer is the topmost layer. If a number of layers are removed (layer sequence), all layers to be removed are adjacent to each other and contain the topmost layer (and therefore form the topmost layer sequence). All layers to be removed later are therefore located above all remaining layers. The terms “topmost layer (sequence)” and “above” refer to the order of the layers starting from the substrate: the topmost layer is the layer with the greatest distance to the substrate surface and a layer is arranged above another layer if it has a greater distance to the substrate surface.

In principle, it is conceivable that one or more layers are removed in the base region as well, as long as fewer layers are removed in the base region than in the decorative region. However, it is preferred if no layer is removed at all in the base region.

The laser radiation is preferably moved over the at least one decorative region (once or several times), wherein the at least one layer is removed by ablation (laser ablation). In particular, the laser radiation is absorbed by at least one layer of the coating, whereupon this layer and any layers located above this layer are removed. The movement speed of the laser radiation is preferably from 10 mm/s to 1000 mm/s, particularly preferably from 50 mm/s to 500 mm/s.

With a fixed laser and a fixed substrate, the laser radiation can be moved over the at least one decorative region by a laser scanner, wherein the laser radiation is suitably moved by a system of movable mirrors. Alternatively, it is also possible to move the laser itself while the substrate is stationary or to move the substrate while the laser is stationary.

The coated surface of the substrate can face the laser. If the substrate is (largely) transparent to the laser radiation (especially in the case of a glass pane), the coated surface can alternatively face away from the laser and the laser radiation can be directed through the substrate onto the coating. In both cases, the laser radiation is preferably focused on the surface of the substrate with the coating. The extent of the laser spots on the coating (diameter) is preferably from 25 μm to 250 μm, particularly preferably from 40 μm to 180 μm.

Laser radiation in the UV range, the visible range or the IR range of the electromagnetic spectrum is preferably used. The wavelength of the laser radiation is preferably from 200 nm to 2000 nm, particularly preferably from 250 nm to 1100 nm, for example from 266 nm to 1064 nm. Particularly good results are achieved thereby. For example, solid-state lasers can be used (e.g. Nd: YAG lasers or Yb: YAG lasers), which can be frequency doubled, frequency tripled or frequency doubled twice, as required. Such lasers are widely used industrially, relatively inexpensive and efficient. Alternatively, diode lasers, excimer lasers, gas lasers or dye lasers can also be used.

The laser is preferably operated in shelled mode. The pulse length of the laser is preferably in the femtosecond or nanosecond range. The pulse length is particularly preferably no more than 10 ps. The pulse length is very particularly preferably from 200 fs to 10 ps, particularly from 500 fs to 1 ps. Particularly good results are achieved thereby. Such short pulses minimise the thermal stress in the laser processing environment, making it possible to process thin layers and even heat-sensitive materials. The repetition frequency of the laser pulses is preferably from 10 KHz to 1000 kHz, particularly preferably from 50 KHz to 400 kHz. The pulse energy is preferably from 200 nJ to 2000 nJ, particularly preferably from 250 nJ to 1000 nJ.

The output power of the laser is preferably from 10 W to 200 W.

The laser radiation used can be adapted to the coating to be processed in order to achieve effective ablation of at least one layer in the decorative region. This is done in particular by selecting the wavelength, which is chosen such that at least one layer of the coating ensures a sufficiently high absorption of the laser radiation (either at least one layer that is already present according to the primary function of the coating, or an absorber layer specially introduced for this purpose). In addition to the wavelength, the laser power, the pulse energy and the pulse length also have an impact and can be selected accordingly, as well as the speed of movement of the laser radiation and the frequency of movement of the laser radiation over the decorative region.

The invention also comprises a pane- or film-like article with a decorative coating, produced by the method according to the invention.

The invention also includes a pane- or film-like article with a decorative coating comprising:
a pane- or film-like substrate,
a coating on a surface of the substrate,
wherein the coating has at least one decorative region in which the coating comprises fewer layers than in at least one base region,
wherein the coating comprises at least one layer in the decorative region and at least two layers in said other partial region.

The above statements regarding the method according to the invention also apply accordingly to the subject matter according to the invention. If the method is preferably carried out in a certain way, the article is equally preferably designed accordingly.

The invention also comprises the use of an article according to the invention in the vehicle or architecture sector (in particular as a window pane of a vehicle, a building or an interior or as a component of such a window pane, or as a facade panel of a building), in furniture or other furnishing articles or as a furnishing article (for example a decorative article).

Window panes can, for example, be designed as single panes of glass. These can be realised if the substrate of the article according to the invention is a glass pane. Alternatively, a plastics pane can be used as a substrate. Such single panes are commonly used in the vehicle sector, especially as side windows or rear windows, as well as in the glazing of simple building-like facilities, such as tool sheds, conservatories, garden sheds, agricultural facilities (e.g. barns) or hunting facilities (e.g. hunting stands).

The article according to the invention can also be part of a window pane, for example a laminated pane or an insulating glass pane. In laminated panes, two panes of glass or plastic are bonded together via a thermoplastic intermediate layer (e.g., a PVB-based film). The article according to the invention is one of the panes (wherein the substrate is designed as a glass or plastics pane, preferably a glass pane) or the intermediate layer (wherein the substrate is designed as a polymer film) or part of the intermediate layer (as one of a plurality of films which form the intermediate layer). Such laminated panes are particularly common in the automotive sector, especially as windshields or roof windows, and increasingly also as side windows or rear windows. But such laminated panes can also be used indoors, for example as a shower cubicle. Insulated glazing consists of two panes of glass or plastic connected to one another by a spacer at the edge, creating a space between the panes which is filled with inert gas or evacuated. The article according to the invention is one of the panes (wherein the substrate is designed as a glass or plastics pane, preferably a glass pane). Such insulating glazing is particularly common in the architectural sector, for example as window panes, door panes or as glass facades.

If the article is used as a facade panel, the substrate is preferably designed as a ceramic panel, stone panel or concrete panel.

For interior applications (e.g. wall panelling, furniture, kitchen fittings, shower cubicles, other furnishings), the choice of substrate is basically completely free. For example, glass panes, plastics films (laminated between two glass or plastics panes) or plastics panes, ceramic plates or stone plates can be used.

The invention is explained in more detail with reference to a drawing and exemplary embodiments. The drawing is a schematic representation and is not true to scale. The drawing does not limit the invention in any way. In the drawings:

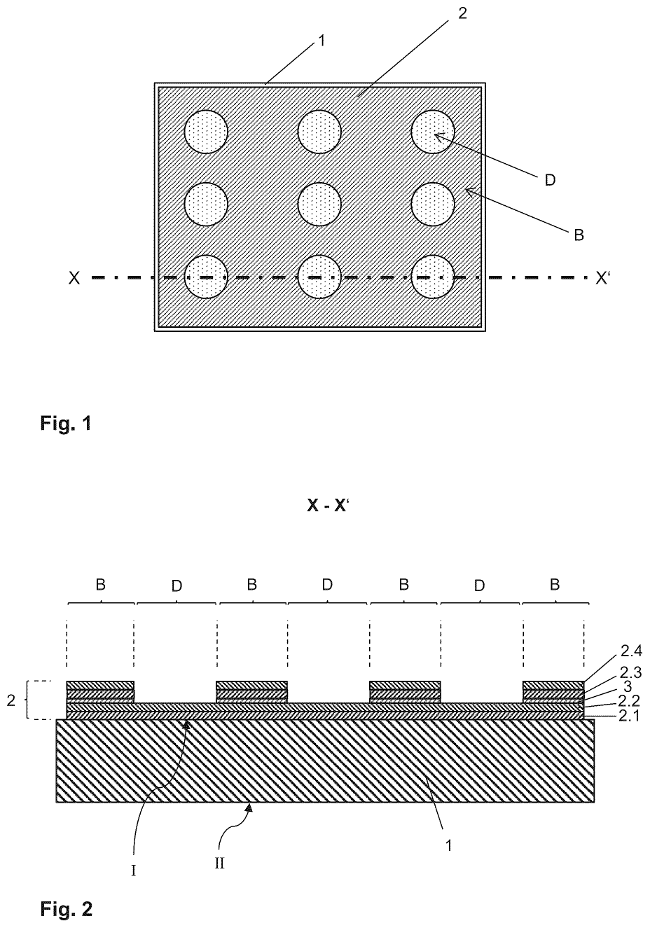

FIG. 1 shows a plan view of an embodiment of the article according to the invention,

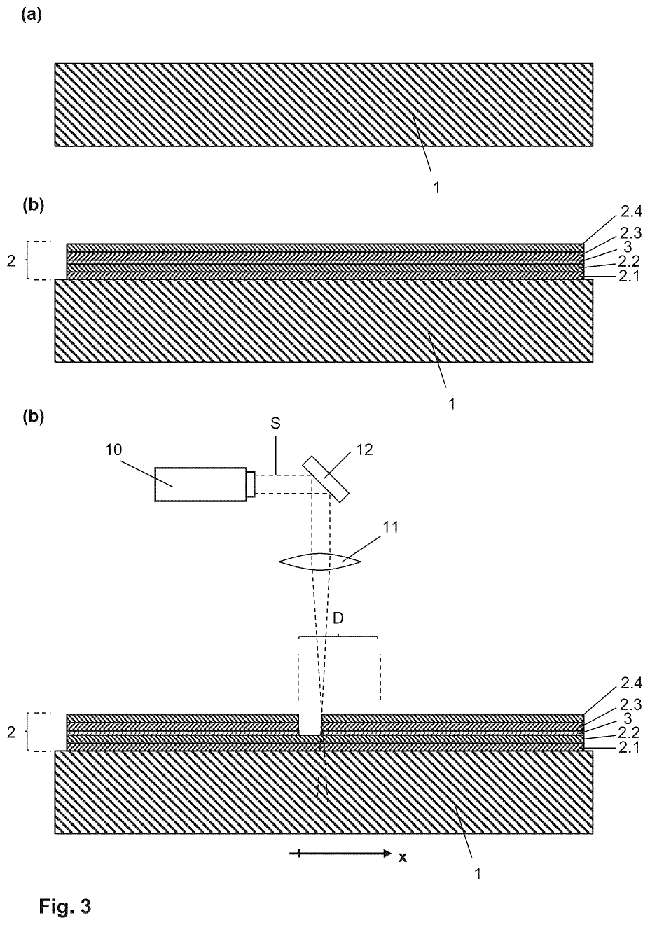

FIG. 2 shows a cross-section along X-X′ through the article from FIG. 1,

FIG. 3 shows a cross-section through the article from FIGS. 1 and 2 during its production using the method according to the invention at three different times,

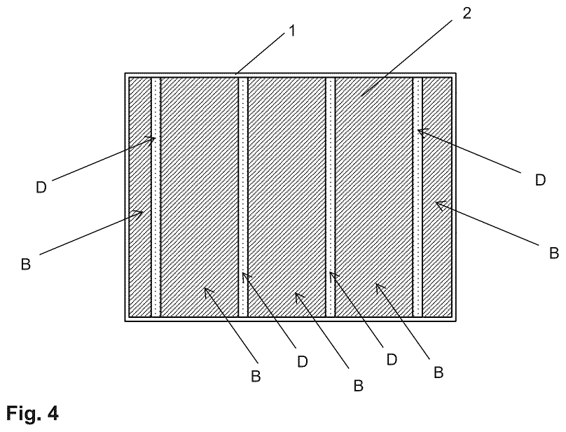

FIG. 4 shows a plan view of a further embodiment of the article according to the invention.

FIG. 1 and FIG. 2 each show a detail of an article according to the invention. It is a pane- or plate-like article formed from a pane- or plate-like substrate 1 and a coating 2.

The substrate 1 is a glass pane made of soda-lime glass with a thickness of, for example, 2.1 mm, which is intended to be used as the outer pane of a laminated pane and to be connected to an inner pane via a thermoplastic intermediate layer. The laminated pane is provided as a roof pane of a motor vehicle, for example. The substrate 1 has two main faces which are intended for viewing through the glass pane, namely a first surface I and a second surface II, as well as a circumferential side edge face extending therebetween.

The coating 2 has a base region B in which a plurality of decorative regions D are arranged in the form of islands. The decorative regions D are shown as circular areas for example. They can be designed in any way, for example in the form of a symbol or a company logo. The decorative regions do not have to be arranged in the form of a regular pattern, as shown by way of example in the figure. It is also possible that there is only a single decorative region D.

The coating 2 is designed as a stack of thin layers and is designed differently in the base region B than in the decorative regions D. In the base region B, the coating 2 has a total of five layers: a first dielectric layer 2.1, a second dielectric layer 2.2, an absorber layer 3, a third dielectric layer 2.3 and a fourth dielectric layer 2.4, which are applied in the specified order starting from the surface I of the substrate 1. In the decorative regions D, however, the absorber layer 3, the third dielectric layer 2.3 and the fourth dielectric layer 2.4 are missing, so that the coating is formed only from the first dielectric layer 2.1 and the second dielectric layer 2.2. An exemplary layer sequence of the coating 2 with materials and layer thicknesses is summarised in Table 1.

TABLE 1

| | | Layer thickness | | | |
|---|---|---|---|---|---|
| | | | | Decorative | |
| Reference signs | Material | Base region B | | region D | |
| 2.4 | SiO₂ | 60 | nm | — | |
| 2.3 | Si₃N₄ | 30 | nm | — | |
| 3 | NiCr | 5 | nm | — | |
| 2.2 | SiO₂ | 60 | nm | 60 | nm |
| 2.1 | Si₃N₄ | 30 | nm | 30 | nm |
| 1 | Soda-lime glass | 2.1 | mm | 2.1 | mm |

Due to the alternating sequence of optically high-refractive layers 2.1, 2.3 based on silicon nitride (Si₃N₄) and optically low-refractive layers 2.2, 2.4 based on silicon oxide (SiO₂), the coating 2 has reflection-reducing properties as a result of interference effects. The coating 2 is therefore an example of an anti-reflection coating, which reduces the reflection on the surface I of the substrate 1.

Since the coating 2 has a significant influence on the appearance of the glass pane, the base region B and the decorative regions D differ optically from one another, in particular by a different degree of reflection and a different colour (reflection colour). The viewer can therefore clearly perceive the decorative regions D. This is the basis for the decorative function of the coating 2.

The design shown here is to be understood as an example only. The article according to the invention can basically have any type of coating 2 as long as it has an influence on the optical properties of the article. The coating 2 can, for example, also be a sun protection coating with at least one silver layer with reflective properties in the near IR range or an emissivity-reducing coating (LowE coating) with an ITO layer with reflective properties in the mid-IR range (in particular in the range of thermal radiation of the substrate 1).

The number of layers in the base region B and the decorative regions D is also only exemplary. Alternatively, it would be possible, for example, that in the decorative regions D compared to the base region B only the topmost dielectric layer 2.4 is missing.

FIG. 3 shows cross-sections through the article from FIGS. 1 and 2 in three method steps of the method according to the invention for its production. First, the substrate 1 is provided (FIG. 3a). On the surface I of the substrate 1, the coating 2 is then applied (FIG. 3b). For this purpose, the layers 2.1, 2.2, 3, 2.3, 2.4 are deposited one after the other on the surface, for example by means of magnetic-field-assisted cathode sputtering I. Subsequently, in the decorative regions D, the topmost three layers 3, 2.3, 2.4 are removed by means of the radiation S of a laser 10. For this purpose, the radiation S is focused onto the coating 2 by means of a focusing element 11, for example a lens or an objective. The radiation S is then moved along a direction of movement x over the entire decorative region D by means of a laser scanning system which comprises at least one (typically at least two) movable, in particular tiltable mirrors 12. The layers 3, 2.3, 2.4 are removed by laser ablation (FIG. 3c).

The radiation S, for example, has a wavelength in the visible spectral range. The laser 10, for example, is a pulsed Yb: YAG laser with an emission wavelength of 1030 nm. Since the dielectric layers 2.1, 2.2, 2.3, 2.4, which produce the reflection-reducing effect of the coating 2, are largely transparent in the visible spectral range, their absorption of the radiation S is not high enough to ensure laser ablation. Therefore, the absorber layer 3 based on an alloy of nickel and chromium (NiCr) was introduced into the layer stack. The absorber layer 3 absorbs the radiation S, whereby it itself and the dielectric layers 2.3, 2.4 located above it are removed. If, instead, a layer system is used as coating 2 which already (according to its primary function) has at least one layer with sufficient absorption of the radiation S, an additional absorber layer 3 provided specifically for this purpose can be dispensed with.

FIG. 4 shows a plan view of a further embodiment of an article according to the invention. The decorative regions D are not arranged here in island-like fashion in a single, contiguous base region B, as in FIG. 1. Instead, a striped pattern is realised. There are several strip-like decorative regions D and several strip-like base regions B. The base regions B and the decorative regions D are arranged alternately so that each decorative region D is arranged between two base regions B.

With the method according to the invention, the article can be decoratively designed in any desired manner. Any pattern can be created and any symbols can be displayed.

### LIST OF REFERENCE SIGNS

(1) Substrate
(2) Coating
(2.1) Layer of coating 2/first dielectric layer
(2.2) Layer of coating 2/second dielectric layer
(2.3) Layer of coating 2/third dielectric layer
(2.4) Layer of coating 2/fourth dielectric layer
(3) Absorber layer of coating 2
(10) Laser
(11) Focusing element
(12) Tiltable mirror
(D) Decorative region of coating 2
(B) Base region of coating 2
(S) Radiation of the laser 10
(I) First surface of the substrate 2
(II) Second surface of the substrate 2
X Direction of movement of the radiation S
X-X′ Cutting line

1. A method for producing a pane-like or film-like article with a decorative coating, comprising the following method steps in the order given:
(a) providing a pane- or film-like substrate,
(b) coating a surface of the substrate with a coating which comprises at least two layers,
(c) removing at least one layer of the at least two layers in at least one decorative region of the coating by means of laser radiation, wherein at least another one layer of the at least two layers remains in the decorative region,
wherein in at least one base region of the coating the at least one layer is not removed.

2. The method according to claim 1, wherein in method step (c) optical properties of the decorative region in the visible spectral range are changed.

3. The method according to claim 1, wherein the at least one layer which is removed in method step (c) is a topmost layer or layer sequence of the coating.

4. The method according to claim 1, wherein the coating has a plurality of dielectric layers.

5. The method according to claim 4, wherein the coating further comprises at least one electrically conductive layer.

6. The method according to claim 5, wherein the electrically conductive layer is an absorber layer based on a metal, a metal alloy or a transparent, electrically conductive oxide with a thickness of at most 10 nm, which has an absorption coefficient with respect to the laser radiation of at least 1%.

7. The method according to claim 1, wherein the laser radiation is moved over the at least one decorative region in method step (c), wherein the at least one layer is removed by ablation.

8. The method according to claim 1, wherein the laser radiation has a wavelength in the UV range, in the visible range or in the IR range.

9. The method according to claim 1, wherein the laser radiation is pulsed with pulse lengths in the femtosecond or nanosecond range.

10. The method according to claim 9, wherein the laser radiation has a pulse energy of from 200 nJ to 2000 nJ.

11. The method according to claim 1, wherein the coating is applied to the substrate by gas phase deposition.

12. The method according to claim 1, wherein the substrate is a glass pane, a plastics pane, a ceramic slab, a stone slab, a concrete slab or a polymer film.

13. A pane- or film-like article with a decorative coating, comprising:
a pane- or film-like substrate,
a coating on a surface of the substrate,
wherein the coating has at least one decorative region in which the coating (2) comprises fewer layers than in at least one base region,
wherein the coating comprises at least one layer in the decorative region and at least two layers in the base region.

14. The article according to claim 12, wherein the at least one decorative region and the at least one base region have different optical properties in the visible spectral range.

15. A method comprising providing an article according to claim 13 in vehicle or architecture sector.

16. The method according to claim 2, wherein in method step (c) the colour of the decorative region in the visible spectral range is changed.

17. The method according to claim 5, wherein the at least one electrically conductive layer is based on a metal, a metal alloy or a transparent, electrically conductive oxide (TCO).

18. The method according to claim 8, wherein the laser radiation has a wavelength in a range from 200 nm to 2000 nm.

19. The method according to claim 9, wherein the pulse lengths are from 200 fs to 10 ps.

20. The method according to claim 11, wherein the coating is applied to the substrate by magnetic-field-assisted cathode sputtering.
